(19) United States
(12) Patent Application Publication
(10) Pub. No.: US 2004/0204174 A1
(43) Pub. Date: Oct. 14, 2004

(54) Method for using system information from a wireless network to predict current consumption in different modes of a mobile telephone

(76) Inventor: Goran Pehrsson, Malmo (SE)

Correspondence Address: JENKENS & GILCHRIST, P.C., Suite 3200, 1445 Ross Avenue, Dallas, TX, 75202-2799, US

(21) Appl. No.: 10/282,352

(22) Filed: Oct. 29, 2002

(51) Int. Cl. H04B 17/00; H04M 1/00; H04B 1/38

(52) U.S. Cl. 455/572; 455/67.11

(57) ABSTRACT

A method for determining current usage in at least one mode of a mobile telephone uses system parameters received at the telephone from a wireless network to determine the current usage for the at least one mode of the mobile telephone.

### TECHNICAL FIELD

The present invention relates to monitoring battery power for mobile telephones, and more particularly, to a method for predicting remaining standby and call time within a mobile telephone

### BACKGROUND OF THE INVENTION

Users of portable battery powered communication devices are dependent on a fully functional device More specifically, the users need to know exactly for how long their devices will remain functional, until the electrical energy stored in the battery has been consumed and the battery has to be recharged. This is particularly true for users of mobile telephones.

In order to determine a precise estimation of the remaining operational time of a mobile telephone, the user needs an accurate and well functioning battery capacity indicator or “fuel gauge”. Determining the remaining battery capacity includes two separate current measurements. One measurement from the current flowing into the battery “charging” and one measurement for the current consumed from the battery “discharging”. The charging current is often relatively easy to measure A microprocessor “CPU” may determine the current signal which is directly proportional to the current flowing through a small resistor Since a microprocessor controls the charging process, it will also have access to all relative data for calculating the total energy, that has been supplied to the battery during a certain period of time.

Determining the discharge current or current consumption is much more difficult, particularly for advanced telephones with complex functionality and many operating modes Traditionally, discharged current is measured by calculating the expected current consumption, when the telephone is in different operating modes. Earlier mobile telephones basically had two operating modes, talk mode and standby mode. With such telephones, the current consumption for talk modes and standby modes was measured once in a test laboratory environment and stored in memory in the telephone as respective, predetermined consumption values. In operation, the telephone would keep track of the time spent in talk mode and standby modes and subsequently calculate the total amount of energy consumed within the battery by multiplying the respective operational times by the predetermined consumption values. Recently it has been possible to use application specific integrated circuits (ASICs) to measure current flowing in and out of a battery.

Existing solutions for determining standby and call time within a mobile telephone involve first calculating the charge taken from the battery enabling estimation of the remaining capacity in the battery and after that calculating a current used by the mobile telephone in different modes, for example, standby and call, to predict how long the battery will last based upon the remaining charge. The remaining time of the battery can be determined from the remaining capacity in the battery divided by the current consumed in a particular mode One method is to count, the number of RX, TX and SYNT strobes and together with prestored energy values for the different strobes determine the amount of current used.

These methods, however, are quite complex to use in practice due to the large amount of measurements that must be done in the lab, and the large amount of data that must be stored in the mobile phone. Each increase the complexity and cost associated with a mobile telephone. Furthermore, while such solutions work well within TDMA systems such as GSM, the solution is not suitable for CDMA systems.

### SUMMARY OF THE INVENTION

The present invention overcomes the foregoing and other problems with a method for determining current usage in at least one mode of a mobile telephone. The mobile telephone receives system parameters from a wireless network associated with the mobile telephone The mobile telephone uses the received system parameters to calculate current usage for at least one mode of the mobile telephone.

### BRIEF DESCRIPTION OF THE DRAWINGS

A more complete understanding of the method and apparatus of the present invention may be obtained by reference to the following Detailed Description when taken in conjunction with the accompanying Drawings wherein.

FIG. 1 illustrates a mobile terminal and network operating according to the method of the present invention; and

FIG. 2 is a flow diagram illustrating a method for predicting current consumption and remaining time in standby and call modes.

### DETAILED DESCRIPTION

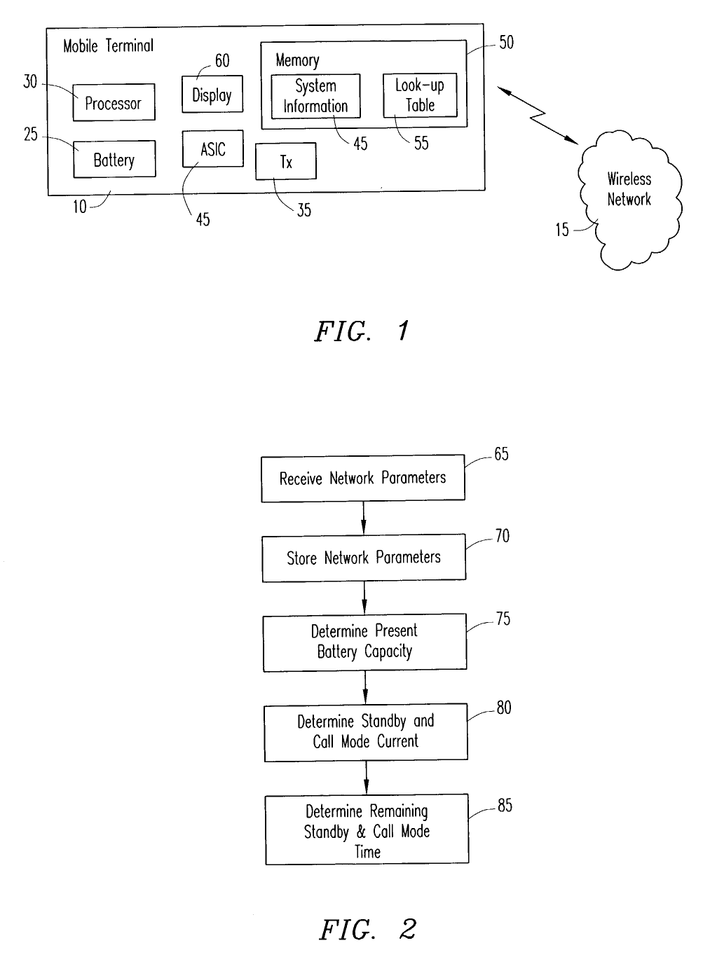

Referring now to the drawings, and more particularly to FIG. 1, there is illustrated a mobile terminal 10 (which may comprise a mobile telephone, PDA, pager, portable computer or any other portable electronic device) for interacting with a wireless network 15 to enable prediction of current consumption in a standby mode, a call mode, or any other mode according to the method of the present invention. The mobile terminal 10 includes an application specific integrated circuit (ASIC) 20 capable of measuring the current flow into and out of a battery 25. This enables a determination of present charge capacity associated with the battery by a processor 30. While the present description describes determining the total charge of the battery 25 in this fashion, it should be realized that a number of methods may be used for determining a total charge capacity within the battery 25

A transceiver 35 enables the mobile terminal 10 to generate a wireless communications link 40 with a wireless network 15. The wireless network 15 may comprise a number of wireless communication network technologies such as GSM, CDMA, UMTS or any other known wireless communications technology. Over the wireless communications link 40, the mobile terminal 10 is able to receive system information provided by the wireless network 15 enabling the mobile terminal 10 to predict current consumption in the standby mode and the call mode.

There is a close relationship between the system parameters provided by a wireless network 15 to the mobile terminal 10 and the actual current consumed by the mobile terminal 10 from the battery 25 in the standby mode and the call mode. The system information may include, for example, a paging rate and number of neighboring cells monitored which assists in determining a current consumed in a standby mode or information such as power levels useful for determining current consumption in a call mode. The examples of paging rate, number of neighboring cells to monitor and power level mentioned above and in the following description are merely intended as examples of system information (parameters) which may be used to predict the current consumption in the standby and call modes of the mobile terminal 10 It should be realized that any system information provided by the network 15 that would be useful in determining current consumption in standby and call modes would also be applicable to the system and method of the present invention.

The provided system information 45 is stored in a memory 50 so that the system information 45 may be used to calculate the current consumed in the standby and call modes of the mobile terminal 10. The system information 45 would be periodically updated within the memory 50 such that any current consumption calculations for the standby and call modes would be based upon the most recently available system information 45 and provide a more accurate picture of the current being used by the mobile terminal 10 The system information 45 may be plugged into a formula to determine the standby and call mode current usage under the control of processor 30. One exemplary algorithm is illustrated below. However, it should be realized that any number of algorithms utilizing system information 45 provided by the wireless network 15 to determine current usage in standby and call modes may also be utilized. In this example, the current (I) is determined with respect to a GSM network according to the following formula:

I=f(x,y)=a+(b/x)=(cy/x)

where:

a, b and c are constants;

x is the paging rate given by the network; and

y is the number of neighbors given by the network

Thus, using this formula a current usage I in a standby mode can be determined.

Likewise, a formula for calculating a call current in a GSM network could be utilized as follows.

I=f(x,y)=a+w(x)/y

where

a is a constant,

x is the power level asked by the network;

w(x) is a formula or a look up table (55) for the relationship between current and output power for the power amplifier; and

y is a parameter depending on if, discontinuous transmission (DTX) is allowed by the network or not (no DTX y=1, DTX y=2)

Similar formulas could be used for UMTS networks The formulas could also be more complex and include more parameters depending on the type of network used and the speed coding used. Additionally, as mentioned briefly above, rather than using algorithms in the control of the processor 30 along with the system information 45, current usage may be determined by a processor 30 controlling a look up process within a look up table 55 that uses the system information 45.

Once the current usage has been determined, this may be utilized to determine a remaining operating time and this information can be shown upon the display 60 of the mobile terminal 10.

Referring now to FIG. 2, there is illustrated a flow diagram describing the manner in which remaining standby and call time may be determined using the method for determining current usage in standby and call modes according to the present invention System information (parameters) 45 is received at step 65 from the wireless network 15. The received system information 45 is stored at step 70 within a memory 50 of the mobile terminal 10. The current battery capacity is determined at step 75 using any known methods or may utilize the ASIC 20 described with respect to FIG. 1 Next, the standby and call current usage is determined at step 80 using the system information 45 stored in the memory 50. The determined current battery capacity and the determined standby and call current usage are used to determined at step 85 the remaining amount of standby and call time remaining for the mobile terminal 10 and this information can be displayed via the display 60

By using system information 45 provided by the network 15, a mobile terminal 10 is able to predict remaining standby and call time This will provide a simple yet sufficiently accurate estimate enabling the mobile terminal 10 to instantaneously adapt to changes in the network No complex algorithms are required and the system information is already read from the wireless network 10 for other reasons. Information will only have to be stored for use in the current usage calculations.

The previous description is of a preferred embodiment for implementing the invention, and the scope of the invention should not necessarily be limited by this description. The scope of the present invention is instead defined by the following claims.

What is claimed is:

1. A method for determining current usage in at least one mode of a mobile terminal, comprising the steps of
receiving system parameters at the mobile terminal from a wireless network; and
determining a current usage for the at least one mode responsive to the system parameters from the wireless network.

2. The method of claim 1, wherein the step of determining further comprises the step of determining a current usage for a standby mode and a call mode responsive to the system parameters for the wireless network.

3. The method of claim 1, wherein the step of receiving further comprises the step of receiving at least one of a paging rate, a number of neighboring cells to monitor, DTX enabled, type of speech coding and a power level at the mobile terminal from the wireless network.

4. The method of claim 1, further including the step of storing the received system parameters at the mobile terminal.

5. The method of claim 1, wherein the step of determining further comprises calculating the current usage for at least one mode with an algorithm responsive to the system parameters.

6. The method of claim 1, wherein the step of determining further comprises looking up a current usage for at least one mode in a lookup table responsive to the system parameters.

7. The method of claim 1, wherein the mobile terminal comprises a mobile telephone.

8. A method for determining remaining battery time in at least one mode of a mobile terminal, comprising the steps of:
receiving system parameters at the mobile terminal from a wireless network,
determining a present battery capacity for a battery in the mobile terminal;
determining a current usage for the at least one mode responsive to the system parameters from the wireless network, and
determining for the at least one mode the remaining battery time responsive to the present battery capacity and the current usage for the at least one node.

9. The method of claim 8, wherein the step of determining further comprises the step of determining a current usage for a standby mode and a call mode responsive to the system parameters for the wireless network.

10. The method of claim 8, wherein the step of receiving further comprises the step of receiving at least one of a paging rate, a number of neighboring cells to monitor, DTX enabled, type of speech coding and a power level at the a mobile terminal from the wireless network.

11. The method of claim 8, further including the step of storing the received system parameters at the mobile terminal.

12. The method of claim 8, wherein the step of determining further comprises calculating the current usage for at least one mode with an algorithm responsive to the system parameters.

13. The method of claim 8, wherein the step of determining further comprises looking up a current usage for at least one mode in a lookup table responsive to the system parameters.

14. The method of claim 8, wherein the mobile terminal comprises a mobile telephone.

15. A mobile terminal comprising:
a transceiver for receiving system parameters from a wireless network, and
a processor for determining a current usage for the at least one mode responsive to the system parameters from the wireless network.

16. The mobile terminal of claim 15, wherein the processor is further configured to determine a current usage for a standby mode and a call mode responsive to the system parameters for the wireless network.

17. The mobile terminal of claim 15, wherein the processor is further configured to receive at least one of a paging rate, a number of neighboring cells to monitor, DTX enabled, type of speech coding and a power level at the mobile terminal from the wireless network.

18. The mobile terminal of claim 15, further including a memory for of storing the received system parameters at the mobile terminal.

19. The mobile terminal of claim 15, wherein the processor is further configured to calculate the current usage for at least one mode with an algorithm responsive to the system parameters.

20. The mobile terminal of claim 15, wherein the processor is further configured to look up a current usage for at least one mode in a lookup table responsive to the system parameters.

21. The mobile terminal of claim 15, wherein the processor is further configured to determine a present battery capacity of the battery.

22. The mobile terminal of claim 21, wherein the processor is further configured to determining for the at least one mode, a remaining battery time responsive to the present battery capacity and the current usage for the at least one mode.
